(19) United States
(12) Patent Application Publication
(10) Pub. No.: US 2019/0151690 A1
(43) Pub. Date: May 23, 2019

(54) FIRE METERING PROTECTION SYSTEM FOR AIRCRAFT

(71) Applicant: Ametek Ameron LLC, Baldwin Park, CA (US)

(72) Inventors: Edwin R. Kho, Norwalk, CA (US); Abdul N. Sitabkhan, Arcadia, CA (US); Souvanh Bounpraseuth, Ontario, CA (US); Michael A. Mallari, Rancho Cucamonga, CA (US)

(21) Appl. No.: 16/310,339

(22) PCT Filed: Jun. 17, 2016
(86) PCT No.: PCT/US2016/038165

§ 371 Date: Dec. 14, 2018

(51) Int. Cl. A62C 3/08; A62C 35/13; A62C 99/00

(52) U.S. Cl. CPC A62C 3/08; A62D 1/005; A62C 99/0018; A62C 35/13

(57) ABSTRACT

A metering cargo fire inerting assembly is activated to supplement an initial release of fire extinguishing fluid into a cargo hold of an aircraft when a fire is detected during flight. The metering components of the fire inerting assembly control the temperature and pressure of the fire extinguishing fluid within a metering container. A heater element within the metering container controls temperature and pressure. A flow control metering orifice is immersed in a portion of the fire extinguishing fluid sealed by a hermetically sealed disc downstream of the metering orifice. A cutter with an internal fluid flow passageway can pierce the disc to release the fire extinguishing fluid under control of a timer attached to the metering container that can activate a pyrotechnic charge to drive the cutter for releasing the fire extinguishing fluid such as Halon 1301 to a discharge outlet for delivery to the cargo hold.

### BACKGROUND OF THE INVENTION

### 1. Field of the Invention

Modern aircraft produced by manufacturers such as the Boeing Company and Airbus SAS provide both increased seating capacity for passengers and increased cargo storage that can serve long range distances approaching 9000 miles. These jet airliners such as the Boeing 767 ER, 774 ER and 777 ER are subject to certification rules by various governmental agencies in different countries, such as the Federal Aviation Administration (FAA) in the United States and efforts are made to coordinate the certification requirements to meet most countries requirements.

The fire extinguishing systems utilized on these jet airliners and on helicopters are required to be certified by the FAA including fire extinguishing systems mounted within the cargo holds and activated by a pilot if a fire is determined. A primary discharge container can release Halon 1301 (Bromotrifluoromethane) to become 5% of the cargo hold volume to initially suppress a fire and subsequently a similar metering discharge container must maintain a 3% volume level of Halon 1301 for a required time period in the cargo hold.

Since these airliners can be traveling at a considerable distance from a possible landing site, there are also requirements to be able to maintain a sufficient level of Halon 1301 within the cargo hold to prevent any re-ignition of the fire for a period of up to three hours. The cargo holds are pressurized by air released from the passenger cabin and have an air leakage rate that can be calculated for each aircraft. Accordingly, a separate metering system is required to maintain a sufficient level of Halon 1301 of 3% of the cargo hold volume for at least three hours of flight time, after the occurrence of a cargo hold fire to comply with FAA regulations. While Halon 1301 is a very good fire suppression agent, it is also a very good refrigerant which provides challenges in any metering technique that can be employed. The Halon agent which can be stored at 300 psig at an ambient temperature, can have a pressure of 200 psig at 0° F. While at higher temperatures the pressure can reach 800 to 1000 psig and therefore the discharge rate of the Halon 1301 can vary with the pressure.

The air from the passenger cabin is released to the cargo holds to equalize the pressure within the interior of the aircraft. Typical cargo holds on aircraft generally will also experience leakage rates from the seals installed around the cargo doors which can cause a continual deletion of the released Halon 1301 concentration from an initial discharge of 5% Halon 1301 by cargo hold volume that was used to extinguish or initially knock down the cargo hold fire.

In addition, such aircraft will be subject to different temperatures both on the ground and in flight throughout its service life and FAA regulations require periodic service checks to maintain a certification of the metering system. Because of various conditions of humidity and temperature during use, moisture can be formed in conduits of the metering system and in the cargo hold as well as in the Halon 1301 fluid which can lead to freezing of any water into ice on small orifices that can disrupt the release of the Halon 1301 into the cargo hold during metering.

### 2. Description of Related Art

Conventional fire extinguishing systems in commercial jet aircraft use one or more primary discharge metering fire suppression Halon 1301 containers. For example, one for a forward cargo hold and one for an aft cargo hold. The pilot will respond to an indicator of a fire in a specific cargo hold in the cockpit and activate a discharge of an appropriate primary fire extinguisher container.

The primary fire extinguisher containers can be 20 inch diameter spheres with 105 pounds of Halon 1301 that can be discharged into the cargo hold within 5-10 seconds to provide a minimum 5% concentration of Halon 1301 by volume initially to suppress the fire while a metering system will be subsequently activated by a solid state timer to maintain a minimum of 3% Halon 1301 concentration by volume for a required time period set by the FAA such as three hours.

The metering system can include one or more metering containers of Halon 1301 that can provide a control release of the minimum 3% Halon 1301 over the three hours.

Both the primary fire extinguisher containers and the metering containers are activated by firing an explosive charge that will rely on the force of the explosion to shatter a sealed disc that seals a 0.75 inch diameter passageway to meet the requirements of a quick knockdown of the initial fire.

The metering containers can use the same type of container as the primary discharge containers and an explosive charge can shatter a sealing disc to provide a quick release of a pressure source of Halon 1301. Additional conventional metering flow control elements downstream of the sealing disc are then required to remove debris of the shattered disc and also to remove any moisture with molecular sieves before delivering the Halon 1301 to a metering orifice to control a release for the three hour time period or selected time periods that add up to three hours when more than one metering container is used to provide a total of three hours at a minimum of 3% by volume of Halon 1301 in the cargo hold.

As noted in U.S. Pat. No. 5,038,867, it is important to prevent the released Halon 1301 from freezing any water that has formed in the conduits that deliver the Halon 1301, particularly in the components of cleaning, filtering and metering of the Halon 1301. This problem of icing can occur by an evaporation process of the Halon 1301 which can produce a drastic drop in temperature and can render the metering extinguishing system inoperative.

Since the Halon 1301 has been released by breaking a hermetically sealed disc by an explosive charge, the Halon 1301 must be filtered to remove solid particles upstream of molecular sieves or a water adsorption filter, and have a pressure reducing stage and a throttle which collectively limits the rate of discharge of the Halon 1301 into the cargo hold.

A conventional container or metering bottle 2 filled with pressurized Halon 1301 will be sealed with a rupturable disc that has been hermetically welded and is operatively positioned adjacent a discharge nozzle 4. An explosive charge or squib can be operatively mounted relative to the discharge nozzle and adjacent the hermetically sealed disc. If there has been a detection of a fire in a cargo hold, a smoke detection monitor can alert the pilot of the existence of a cargo hold fire. The pilot can remotely release the pressurized Halon 1301 into the cargo hold to suppress or knock down the initial fire. This initial act of the pilot automatically activates a solid state timer that will enable a subsequent release from one or more metering bottles to ensure that a 3% by volume of Halon 1301 is maintained over a subsequent time period set by the FAA. The pilot does not directly activate the release from the metering containers since this is controlled by a solid state timer programmed into an avionic computer in the cockpit of the aircraft, which takes into account the particular characteristics and leakage rates of an aircraft's cargo hold.

Referring to FIG. 1, a schematic representation of a conventional metering bottle 2 and discharge nozzle 4 is shown. Downstream from the discharge nozzle 4 are the various conventional metering flow control elements such as a solid particle filter 6 to prevent any debris from being transported downstream. For example, the disc may be ¾ inch in diameter and will be frangible so that it will be shattered with an explosion of the explosive charge. The resulting debris from the disc is filtered by the solid particle filter 6. A sealed molecular sieve filtration unit 8 has a capacity of absorbing water that may accumulate with any changes of temperature, humidity and operating locations of the aircraft. The purpose of the molecular sieve filtration unit 8 is to prohibit any formation of ice that can alter the release of a necessary amount of Halon 1301 into the cargo hold to maintain the 3% volume. The molecular sieve filtration unit 8 uses an upstream check valve 10 and a downstream check valve 12 to prevent any damage to the molecular sieve filtration unit 8. Additionally, a bypass relief valve 14, and a pressure switch 16 can monitor an output flow of the Halon 1301 from the molecular sieve filtration unit 8. An adjustable pressure regulator 18 is used to control the pressure variations in the flow of the Halon 1301 and nitrogen under super pressure. A non-return check valve 20 is mounted upstream from a flow restrictive orifice 22.

As can be appreciated, the Halon 1301 has been pressurized with an inert gas such as nitrogen and when passing through a flow restrictive orifice 22 can turn any H₂O moisture into ice that would disrupt Halon 1301 flow and the necessary metering to maintain the 3% by volume Halon 1301 in the cargo hold.

Various operational conditions of the metering system can cause the Halon 1301 to assume a vapor or gaseous state depending upon temperature. The vapor state of the Halon 1301 will include nitrogen enriched molecules because the container 2 can be pressurized to 360 psi depending on the particular system.

The pressure switch 16 can be activated by the pressure of the released Halon 1301 to inform the pilot that the metering system is now active and is functioning. Prior to the rupturing of the hermetically sealed disc there is no pressure downstream from the metering bottle 2 and the pressure switch 16 informs the pilot that the metering system is not active. The bypass relief valve 14 is to prevent the molecular sieve filtration unit 8 from being over pressurized and any excess fluid would be released to the cargo hold. The molecular sieve filtration unit 8 primary job is to remove moisture but also will remove any particles if they pass through the solid particle filter 6.

The Halon 1301 will have different densities depending on the pressure and temperature. For example, at a −40° F. the Halon 1301 density is different than if it was at +130° F. The molecular size of the vapor which is not a pure gas of Halon 1301, but also has nitrogen enriched molecules because of a pressurization to 360 psi in a conventional metering bottle 2. Water could be found in a conventional metering bottle itself or could be in the lines that are connected for transporting the Halon 1301 to the molecular sieve filter unit 8. There are times when the aircraft cargo hold is open, for example during loading of cargo, and there can be leakage as the aircraft is flying up and down that could induce some moisture to go into small openings. There could also be moisture in the valves when the system is in operation that can be forced into the released Halon 1301, and it is necessary to remove and dry out the moisture to prevent any interference with the metering such as ice freezing in the flow restrictive orifice. The aircraft, for example, can be in an arctic area such as Alaska, and sitting with the cargo hold open, when the plane can be pulled into the gate for loading. The cargo hold may be heated but generally not sufficiently enough to remove any moisture.

When the flight takes off and if a fire occurs in the cargo hold, it could be at different temperatures. Accordingly, any moisture that is contained in the Halon 1301 could be subject to a drop in temperature of a −80° F. or a −100° F. and it will freeze and can clog the metering system such as a flow restrictive orifice 22 shown in FIG. 1. A pressure switch 16 monitors the activation of the metering system when it is loaded under pressure with Halon 1301 and thereby provides a pilot with a signal that the metering system is activated and is being protected. This is just an informational message to the pilot that shows up on his computer. The adjustable pressure regulator 18 can be set and held to a desired pressure that will be appropriate and complementary to the flow restrictive orifice 22 to provide the 3% of Halon 1301 for over the required operational time period of the conventional metering bottle 2. As can be appreciated, there can be more than one conventional metering bottle that is required. The nitrogen pressurized Halon 1301 at a −40° F. could produce approximately 160 psi in the metering bottle 2. If there is an increase or a higher temperature of 140° F., you might have 650 psi in the metering bottle 2. The adjustable pressure regulator 18 is to provide a narrower range of pressure and flow before the flow restrictive orifice 22. The flow restrictive orifice 22 has a fixed opening that could be as small as 10,000ths of an inch in diameter. Accordingly, the adjustable pressure regulator 18 and the metering flow restrictive orifice 22 are initially calibrated based on the amount of time that the Halon 1301 is to be released from the conventional metering bottle 2. There is no dynamic control system that self corrects. The only time a feedback is used is during the testing and certification of the fire extinguisher system in the aircraft before it is certified. Existing conventional systems have used temperature compensated orifices to negate density and temperature changes. This, however, adds another complexity to the conventional system.

Modern cargo holds are pressurized by a release of air from the passenger compartment and the cargo compartment subsequently dumps the air overboard during flight. To maintain the integrity of the fuselage of the plane, the cargo hold is required to equal the pressure in the passenger compartment. The metering system shown in our FIG. 1 has been utilized on international aircraft since at least the year 2000 to the present time. The purpose of airplane cargo fire extinguishing systems is to prevent a cargo fire from growing during flight and endangering the passengers, crew and viability of the airplane. The FAA requires the cargo fire extinguishing system to control or suppress the fuel until the airplane can land at a suitable airport and more direct, aggressive fire extinguishing tactics can be applied to the fire.

The Department of Transportation Federal Aviation Administration issued general guidelines for measuring fire extinguisher agent concentrations as Advisory Circular No. 20-100 in 1977. The current system shown in FIG. 1 for metering the discharge of Halon 1301 to a cargo hold has been implemented in aircraft produced by Airbus, SAS and the Boeing Company and other airlines. The necessity of validating the operability of such a system by periodic checks of the equipment to meet the safety requirements of the FAA increases the cost of operation of such planes. See, Onboard Inert Gas Generation System (OB1GGS) Study, Part 1 Aircraft System Requirements NASA/CR-2001-210903, May 2001, Pg. 51.

The majority of Boeing airplane cargo holds utilize flow-through smoke detectors in the cargo compartment smoke detection systems. A flow-through detection system consists of a distributed network of sampling tubes, which bring air sampled through various ports in the cargo compartment ceiling to smoke detectors located outside the cargo compartment and then exhaust the air. An area detection system can consist of a plurality smoke detectors installed at various locations in the cargo compartment ceiling.

Once smoke is detected by either type of system, aural and visual alarms are annunciated in the flight deck. A light on the applicable fire extinguishing arming switch is illuminated in the airplane flight deck and a crew alerting system (CAS) message is displayed, alerting the flight deck crew to the cargo compartment fire.

The knockdown system in Boeing airplane cargo fire extinguishing systems consist of the Halon 1301 bottles discharged through a distribution tubing system to discharge nozzles in the respective cargo compartment ceiling. In addition to the bottles and distribution system, the knockdown system includes necessary wiring and control circuitry. The knockdown system is sized as a function of compartment volume, temperature, and cabin altitude and typically takes 1 to 2 min to reach maximum concentrations.

Based on a Study from NASA regarding Onboard Inert Gas Generation System/Onboard Oxygen Gas Generation System (OBIGGS/OBOGS), NASA/CR-2001-210903, May 2001, page 64, Class C compartment Halon knockdown system has as little as 33 pounds of Halon 1301 for the 737-800 to as much as 137 pounds for the much larger 777-300 cargo compartments. The 747-400 Class B main deck compartment discharges 294 pounds of Halon 1301 in its knockdown system. Class C compartment leakage rates vary from as little as 11/ft³/m on the 757-300 to as much as 99 ft³/m on the 777-300 airplane. The 747-400 Class B main deck compartment leakage rate was 955 ft²/m. Halon distribution systems are designed to discharge Halon evenly throughout the cargo compartment.

The metered system is either discharged at the same time as the knockdown or after a specified time delay and provides a steady-state Halon flow rate to maintain compartment Halon 1301 concentrations above a minimum level for a specified duration. The metered system typically includes fire extinguishing bottles, a filter/dryer, a regulator, controlling orifices, a distribution tubing network, discharge nozzles in the ceilings of the cargo compartments, and the necessary wiring and flight deck control. The filter/dryer removes possible contaminants from the Halon discharge. The regulator and controlling orifice function to maintain a constant Halon 1301 flow rate. The metered flow rate is a function of compartment leakage. The higher the compartment leakage rate, the higher the Halon flow rate must be to compensate. Cargo compartments are generally designed to minimize compartment leakage when in a fire mode to maximize Halon retention and to reduce smoke penetration effects.

### SUMMARY OF THE INVENTION

The present invention provides a metering cargo fire inerting assembly that can do away with components in the flow metering pneumatic diagram shown in the prior art of FIG. 1, while extending the service life and reliability of a metering cargo fire inerting assembly. Our improved metering bottle for storing a pressurized fire extinguishing fluid such as Halon 1301 incorporates a flow control metering orifice that is connected to and extends from the metering bottle while being sealed for immersion in the fire extinguishing fluid. Fittings and a hermetically welded boss that supports the flow control metering orifice can be connected to a discharge outlet nozzle positioned downstream of the metering orifice. A rupturable disc assembly is hermetically sealed by welding to a fitting housing of a discharge outlet nozzle which supports an integrated hollow cutter with a pyrotechnic squib or cartridge that can be electrically activated to drive the hollow cutter for piecing a sealing disc so that a Halon 1301 and nitrogen mixture can be released through the hollow cutter at a position downstream of the flow restrictive orifice. Accordingly, issues associated with debris from a conventional large ¾ inch rupturable disc assembly, and the problem of potentially freezing water in the flow restrictive orifice are addressed with a fluid conduit through the cutter as the fire extinguishing fluid is transmitted to the cargo hold aircraft tubing for distribution within the cargo hold. The necessity of a molecular sieve filtration unit, the problem of debris from a shattered sealing disc and the replication of the components of the prior art pneumatic diagram of FIG. 1 have been removed with additional security of a long service life for the operability of the metering cargo fire inerting assembly of the present invention.

To further control the parameters in designing our metering cargo fire inerting assembly, we provide an electric heater with an integrated temperature controller that is hermetically welded to the metering body of our current invention to actively interface with the liquid Halon 1301. The heating element can control the Halon 1301 pressure range from 300 psig to 800 psig. Thus, the parameters of setting the sizes of our flow restrictive orifice, the passage size of the hollow cutter to provide a known flow orifice from the hollow cutter can assist in selecting a proper metering orifice that can also double as the previous regulator as well as the flow control valve. Our metering orifice is now within the interior of the released metering bottle fluid and the temperature of the fluid is controlled and capable of preventing any moisture contamination while regulating the range of pressure of the Halon 1301 which directly relates to the rate of Halon 1301 discharge. We can further use the hollow cutter with a predetermined flow orifice size through the cutter tube to help control the pressure and flow of Halon 1301. Our metering cargo fire inerting assembly will not require any maintenance from a ground crew in preparation for each flight, therefore providing a significant savings for the airline and lower any requirements of checking by the ground crew. Additionally, our invention qualifies for a non-explosive classification for our pyrotechnic cartridge that facilitates handling and lowers transportation costs. Finally, the maintenance and functional testing required by the prior art are not necessary with our new design.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a schematic drawing of a metering system for a conventional fire extinguishing system utilized for cargo holds in aircraft since approximately 2000;

FIG. 2 is an exploded view of the present invention metering the fire bottle;

FIG. 3 is an assembled view of the metering fire bottle for mounting in the aircraft;

FIG. 4 is a partial cross sectional view of the metering fire bottle, cutter cartridge and discharge outlet;

FIG. 5 is a partial cross sectional view of the cutter cartridge after piercing the rupture disc to release the pressurized Halon 1301; and

FIG. 6 is a schematic view of an aircraft with meter bottles, a forward cargo hold and a rear cargo hold.

### DETAILED DESCRIPTION OF THE PREFERRED EMBODIMENTS

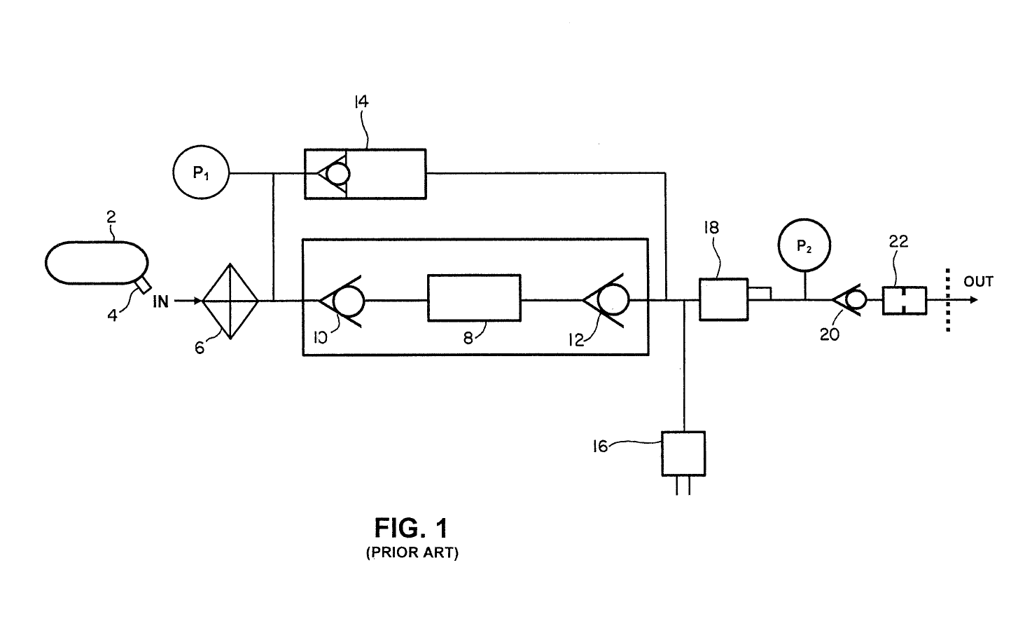

Before describing our invention, reference is made to the prior art schematic of FIG. 1 that is utilized in extended flight jet airliners manufactured by the Boeing Company and Airbus SAS when the cargo compartment smoke detection system detects a fire in a cargo hold. Both aural and visual alarms are enunciated to the pilot in the flight deck and a light on the fire extinguishing arming switch is illuminated to alert the flight deck crew to a cargo compartment fire. The pilot activates a primary knockdown system of firing a pyrotechnic squib or cartridge that is positioned adjacent a hermetically sealed and frangible disc of approximately ¾ inch in diameter wherein the explosion fractures the disc and releases the fire extinguishing pressurized fluid such as Halon 1301 fluid pressurized by nitrogen or another inert gas to enable the fire extinguishing fluid to be discharged in approximately 5 to 10 second. Fire extinguishing containers or bottles can be 2,000 cubic inch bottles with 105 pounds of pressurized Halon 1301 in one or more bottles.

A piping system directs the fire extinguishing fluid to nozzles that can be located, for example, in the ceiling of the cargo hold to serve the primary function of knocking down the fire in a very short time period. To achieve this effect, 5% by volume of the cargo hold will now contain a fire extinguishing fluid such as the Halon 1301.

The FAA regulations, however, also require the cargo hold to maintain at least 3% Halon 1301 for a period of one to three hours to prevent any re-ignition of the fire and to permit the aircraft, where possible, to seek a landing site for the aircraft. To accomplish the extended time period, a secondary fire extinguisher metering system with dedicated metering bottles of pressurized fire extinguishing fluid would automatically be activated by a solid state timer that has been set by an avionic computer at the aircraft level.

The aircraft may utilize one or more metering bottles and they can have the same configuration of a rupturable hermetically sealed disc that can be released with an explosive pyrotechnic cartridge as with the initial knockdown container. The metering bottles may contain 60 pounds or more of Halon 1301 plus a pressurizing nitrogen. The metering bottles will release the Halon 1301 in four or five seconds of the timing discharge, but the conventional metering system disclosed in FIG. 1 is constructed to maintain the 3% Halon 1301 for extended hours by releasing the Halon 1301 through a restricted orifice downstream from the ruptured disc.

Referring to FIG. 1, a prior art metering system is disclosed where a first metering bottle 2 has a discharge nozzle 4 communicating with a hermetically sealed rupturable disc. Downstream from the discharge nozzle 4, a filter or a screen 6 is utilized to remove any debris from the ruptured disc before it enters a molecular sieve 8 that is required to remove any moisture that may have accumulated during the service life of the metering system. The check valves 10 and 12 isolate the molecular sieve 8 to protect it from being over pressurized. A pressure relief valve 14 further protects the metering system from being over pressurized while an adjustable pressure regulator 18, that can be set for a particular size of the cargo hold and held in that pressure range, is provided downstream of the molecular sieve 8. A pressure switch 16 connects to an avionic warning system in the aircraft to provide a visual signal to the pilot that the metering system is operational. Downstream of the pressure regulator 18 is another check valve 20 that is positioned upstream from a flow restrictive orifice 22. The molecular sieve 8 functions in removing any water that could freeze in the flow restrictive orifice 22 that must stay operative for the extended time required.

A pair or more of separate and independent metering bottles could be used, each with an operation life to meet the extended times. Subsequently, a similar metering bottle system can be activated automatically by the solid state timer after the first metering bottle is exhausted to maintain the Halon 1301 at a level of 3% for another period of time, thereby meeting the FAA requirements of the total extended time.

As the fire extinguishing fluid flows through the various valves and narrow orifices, some of the Halon 1301 which is generally in a liquid state with vapor pressure at an ambient temperature ambient. This state can vary from all liquid at a temperature of −65° F. to all gas with nitrogen enriched molecules at a temperature of above +130° F. to 180° F. which can be converted into a vapor with nitrogen enriched molecules. Depending on the temperature, it can have different densities and the molecular size of the vapor can be correspondingly of different values. Thus, besides removing the disc debris and the results of the explosive charge that ruptures the hermetically sealed disc, there is a potential for moisture to be induced within the system, which must be addressed by the molecular sieve filter 8, but moisture can also be further induced into the valves, tubing and the restrictive orifice 22 which must be a very small opening and there is a potential for the metering device to freeze the water into ice. The metering orifice is a stationary opening that can be as small as 0.010 inch diameter to be able to maintain the 3% Halon 1301 for the extended minutes in the cargo hold from each of the metering bottles. The flow orifice 22 has to deal with the molecular size of the Halon 1301 fluid at different temperatures of moisture plus the expansion of the Halon 1301 through any small orifice can cause a “refrigeration” effect due to quickly plummeting of the temperature at the orifice even when the Halon 1301 can be at a higher ambient temperature.

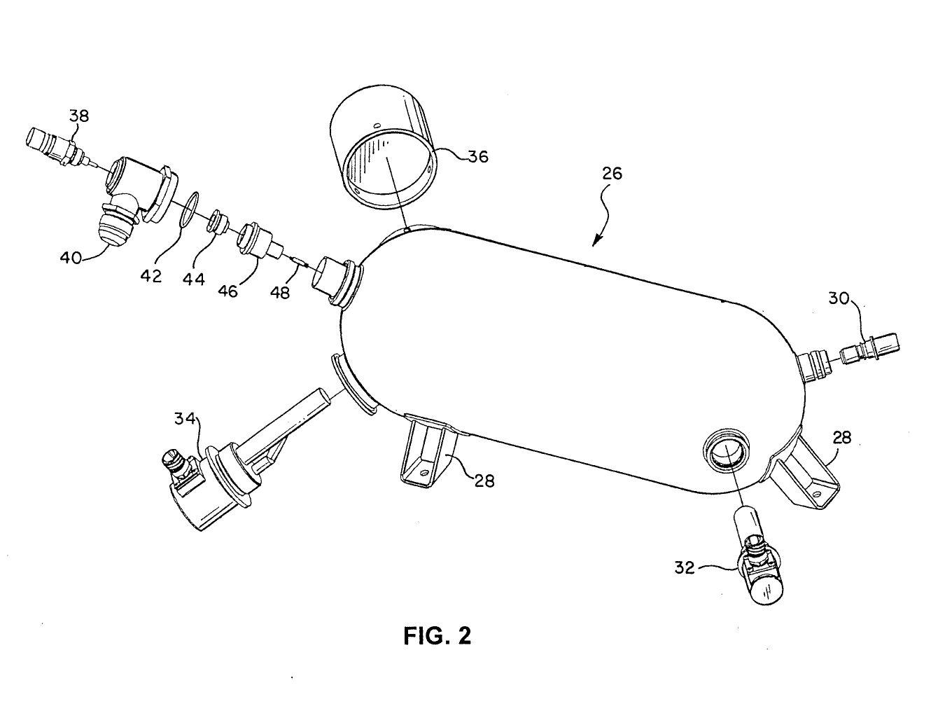

Referring to FIG. 2, a partial exploded view of the components attached to a new metering fire bottle 26 of our invention is shown. The metering fire bottle 26 is preferably made from a lightweight material such as stainless steel that can withstand the temperatures and inert gas pressures that can occur during its service life in the aircraft. Mounting brackets 28 permit the metering fire bottle 26 to be appropriately located adjacent the cargo hold.

A fill fitting 30 comprises an introductory port for the Halon 1301 and for pressurized nitrogen or some other inert gas to fill the metering fire bottle 26. The fill fitting 30 can also act as a pressure relief valve at a predetermined pressure to prevent the fire bottle 26 from being overpressurized. A heater 34 is provided for maintaining a predetermined range of temperature to the fluid within the metering fire bottle 26. The location and orientation of the heater element stem is configured to be immersed within the liquid Halon 1301. The heater may be provided with its own “thermostatic switch” to carefully control the temperature switch range of the fluid 1301 within a desired narrow range. A temperature compensated pressure switch (TCPS) 32 is designed to monitor leakage from the container at all temperatures and in addition will signal the usage of the “secondary metering” system to the cockpit. An example of a TCPS can be found in the Sitabkhan et al. U.S. Pat. No. 8,443,650.

A timer 36 is dedicated to the specific metering bottle. The timer can be set for activating the release of the Halon 1301 consistent with the particular characteristics of the aircraft such as known leakage rate of air from a cargo hold of a particular size, the normal operational altitude of the plane, and the temperature of the cargo hold. The timer 36 has a solid state configuration and is directly attached to each specific metering fire bottle 26. This removes the prior requirement of utilizing the avionic computer to be relied upon to provide the appropriate timing for the metering bottles. Programmable time delay specialty relays that are programmable such as the SCF Series from TE Connectivity Ltd., Reheinstrass 20, CH-8200 Schaffhausen, Switzerland can be used with a D.LO. Power Source.

As shown in FIG. 2, an exploded view of the cutter cartridge 38, discharge outlet 40, sealing O ring 42, and a thin disc 45 which can be frangible and approximately 0.008 inches in thickness with a diameter of approximately ¼ inch is hermetically sealed to the flow regulator housing 44. The thin disc 45 is located downstream of the restrictive orifice 48 and has been selected to be pierced in a controlled manner by a hollow cutter shaft 54 with an interior fluid passageway 56 for releasing the Halon 1301. The internal diameter of the fluid passageway 56 will be larger than the metering orifice 48.

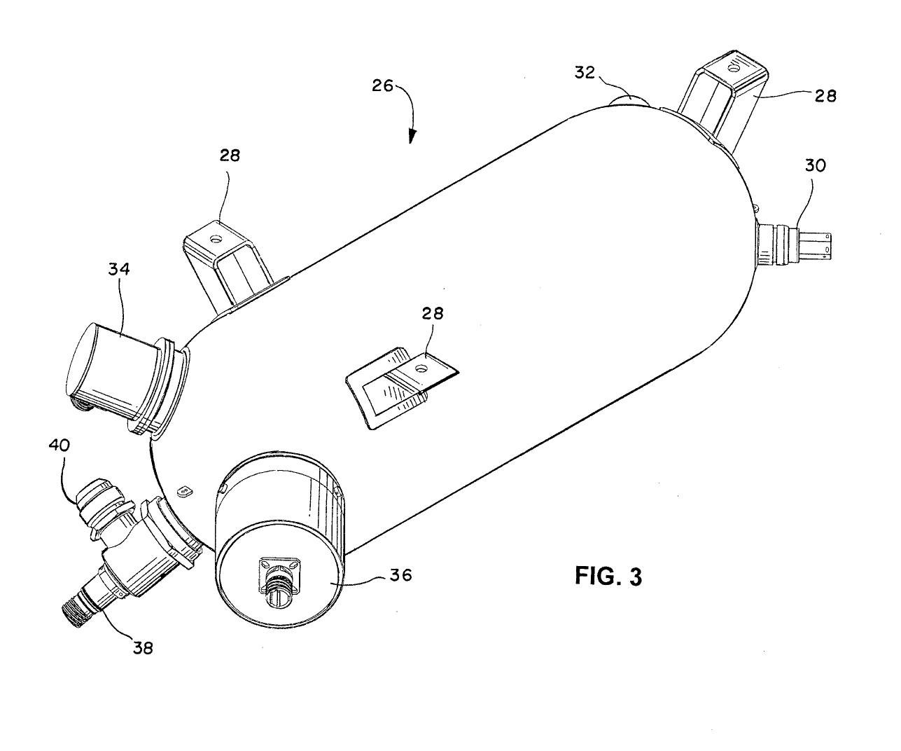

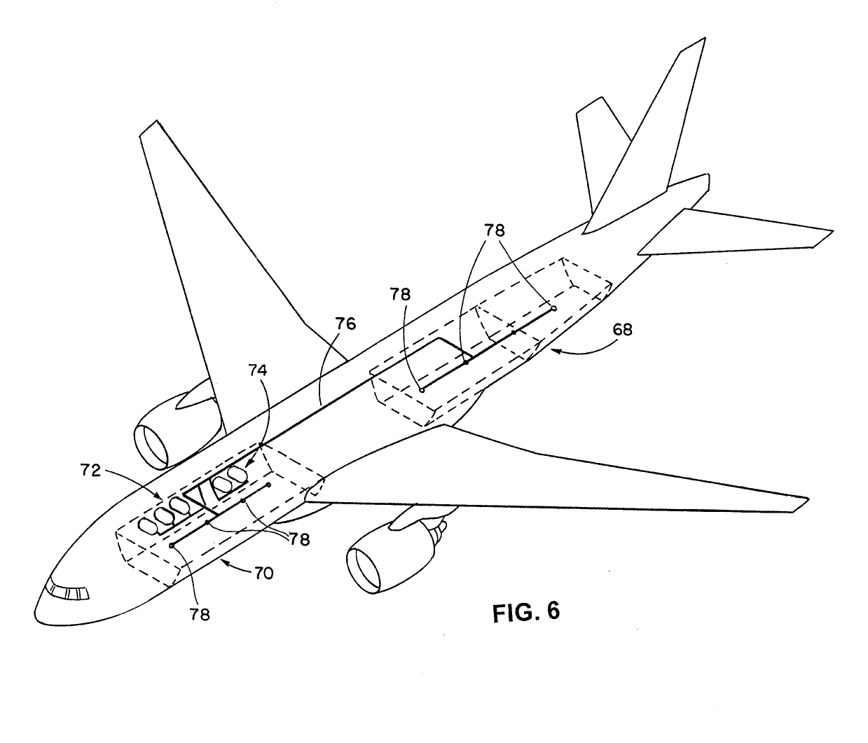

Referring to FIG. 3, the metering bottle 26 is shown inverted so that the mounting brackets 28 can be mounted to suspend from a hanging position adjacent the cargo hold. Appropriate conduits or pipes 76 can be attached for connection to nozzles 78 that can be located, for example, in the ceiling of the cargo hold, see FIG. 6, to permit a fast dispensing of initially the knockdown 5% of Halon 1301 and then subsequently dispensing the Halon 1301 from the metering bottle or bottles to maintain a 3% by volume of Halon 1301 to prevent any re-ignition of the fire during the extended operation time.

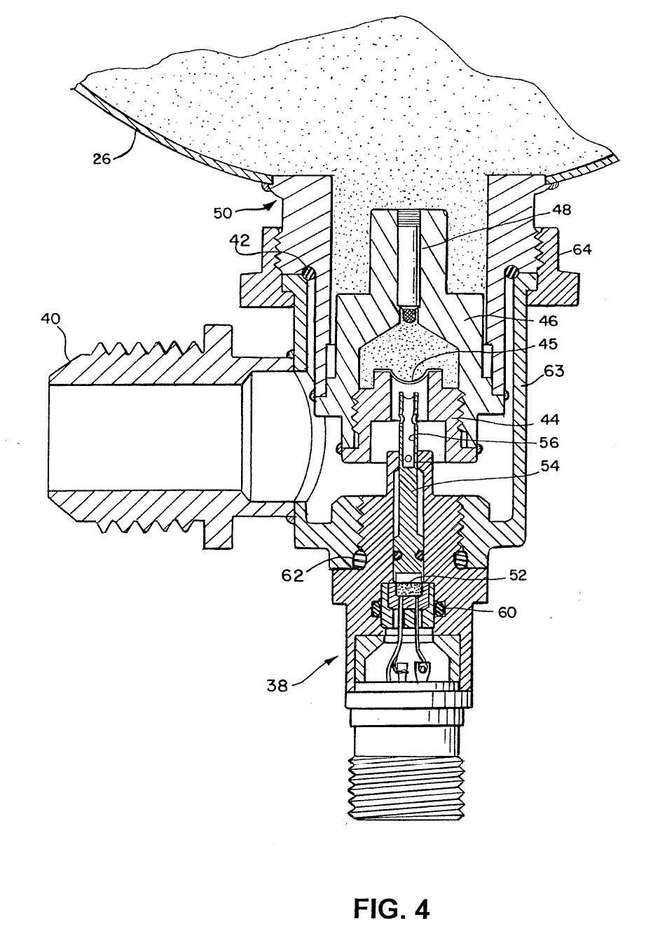

FIG. 4 discloses a cross-sectional view of a portion of our metering bottle 26 with our restrictive orifice 48 mounted against a beveled opening to precisely position the orifice 48 within a flow regulator housing 46 and extending outside of the fluid container or bottle 26 exterior perimeter. Though not shown, the restrictive orifice 48 has an interior passageway with an opening for metering the pressurized fire extinguishing fluid. An O ring 42 assists in sealing a discharge outlet 40 and its swivel housing 62 to a port 50 hermetically sealed to an opening in the metering bottle 26. The swivel housing 62 facilitates an initial rotation to connect the discharge outlet 40 to a pipe for transportation of the Halon 1301 to a nozzle in a cargo hold. The lower cylindrical end of the port 50 has been designed to be welded to the flow regulator housing 46 and is of sufficient length that the weld can be cut away to reweld a new regulator housing assembly 46 after the metering bottle has been discharged. The length of the boss port permits rewelding twice more if necessary.

The restrictive orifice 48 can be as small as having a hole of 0.010 inch diameter depending upon the actual volume of the cargo hold and the characteristics of the aircraft. Our invention recognizes that by keeping our metering restrictive orifice 48 integrated in the fluid from the metering bottle 26, that we can address a large number of the prior problems that require a moisture molecular sieve and filtering systems of the prior art.

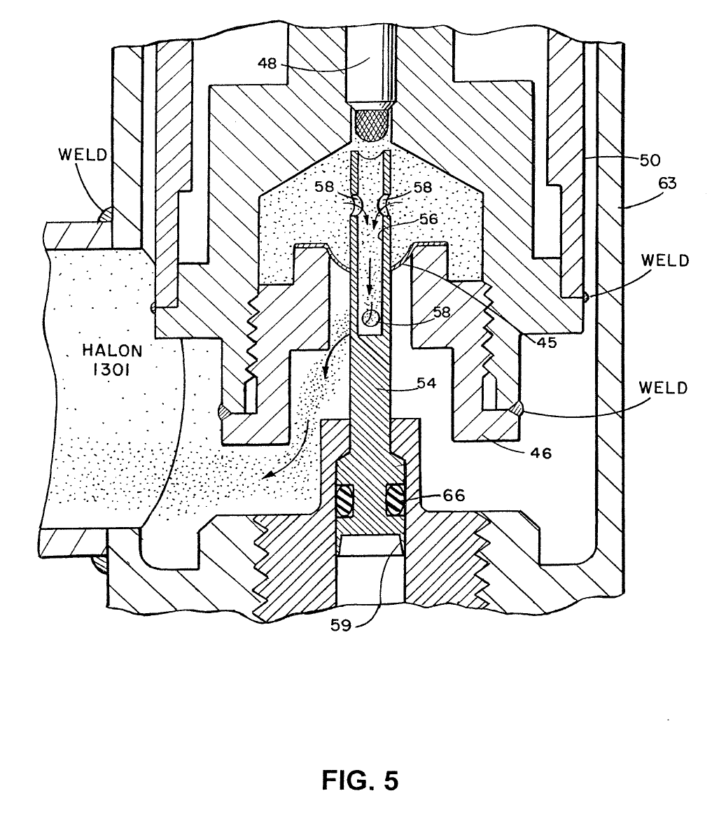

Additionally, instead of using the force from an explosive charge to open a ¾ inch disc of the prior art, we use a metal hollow cutter shaft 54 designed to pierce a hermetically sealed rupturable disc 45 on the housing 44 that will provide another restriction to the flow while ensuring that the cutter 54 is lodged within the ruptured disc 45 in a controlled manner as shown in FIG. 5 and does not interfere with our restrictive orifice 48. Our cutter cartridge 38 can be electronically activated to activate a pyrotechnic charge 52 that will drive the hollow cutter shaft 54 to pierce and be impaled in the thin rupturable disc 45. The cutter shaft 54 can be ⅛ inch in diameter with a pair of upper side holes 58 that will be positioned, after activation, downstream and adjacent to the restrictive orifice 48 with another pair of lower holes 58 below the ruptured disc 45 for releasing the fluid passing through the hollow cutter 56 so that it can extend in a metered manner out of the discharge outlet 40. The opening through which the hollow cutter 56 will travel through the cutter cartridge 38 to pierce the disc 45 has a slanted shoulder that captures an enlarged end of the cutter shaft 54 and limits the movement and final position of the hollow cutter shaft 56.

According to prevailing Department of Transportation (DOT) rules, a cutter cartridge that meets noise and movement requirements is classified as a “Non-Explosive” component. The advantages to an airline or a private customer are huge as this device, which has a “limited life” in service, can be transported through countries throughout the world with no special handling or paperwork required.

When the metering fire bottle 26 is filled with a mixture of Halon 1301 or other appropriate fire extinguishing fluid, with an inert pressurized source such as nitrogen, the fire extinguishing fluid will flow through the restrictive orifice 48 and fill the opening in the flow regulator housing 46 that is positioned above the rupturable disc 45. As can be appreciated, the thermostat in our heater element 34 will control the temperature range and fluid pressure and the restrictive orifice 48 will be immersed within the Halon 1301 fluid at the same temperature. The ¼ inch diameter of our rupturable disc housing will not be blown open by our explosive charge 52 but rather, the explosive charge will drive the hollow cutter 56 to be impaled within the ruptured disc 45. The rear edges 59 of our cutter are further designed to prohibit a retraction of the cutter 56 from the ruptured disc 45.

A precision restrictive orifice 48 for a low flow rate, can be selected in accordance with the design specifications available from the Lee Company, 2 Pettipaug Road, Westbrook, Conn., see www.theleeco.com. The design parameters will take into consideration the flow rates of air passing from the passenger compartment to the cargo hold and being released outside of the aircraft. Additionally, leakage from the seals for the doors of the cargo hold will be considered to determine a dilution rate of the Halon 1301 for the specific aircraft, taking into consideration also the general temperature of the cargo hold and its effective volume. In this regard, numerous aircraft utilize aluminum cargo containers that are sealed with cargo loaded into these containers. As can be appreciated, the manner of storing cargo within the cargo hold will occupy some of the volume of the cargo hold. These factors are taken into consideration in a conservative determination of the specific effective opening in the precision restrictive orifice 48 to be used under the fluid pressure ranges provided by our electric heater 34.

The use of an electric heater 34 to narrow the potential temperature and pressure range in the container or metering fire bottle 26 with the heater 34 effectively immersed in the fire extinguishing fluid enables us to rapidly heat the fluid to a temperature that we can set and control.

A further advantage of our system is that the explosive charge 52 in the cutter cartridge 38 is limited to only driving the bottom cutter base like a piston for piercing the ruptured disc 45 with the front edge of the cutter 54. An O-ring 66 on the cutter base helps to hold and seal the explosive charge 52 and resulting gases. Since the explosion is held and contained within a hollow chamber beneath the cutter 54, it is classified by DOT standards to be a “Non-Explosive” device and does not require special procedures to treat it as an explosive. This results in advantages to the end user such as transportation of a replacement cutter cartridge 38. Thus our design further eliminates the requirements for maintenance and security checks that would be required in a conventional metering system shown in our FIG. 1. Our flow restrictive orifice 48 is surrounded by liquid Halon 1301 and hermetically sealed from the environment. The opening in the cutter shaft for passing the Halon 1301 that has been metered to satisfy the 3% by cargo volume of Halon 1301 employs a hollow passageway 56 in the cutter shaft 54, having a diameter which is slightly bigger than the restrictive orifice 48, thereby permitting the Halon 1301 agent to flow smoothly into the discharge outlet 40 and through the piping system to the cargo hold. The prior art has used metering devices that are exposed and can be accessed. Our metering device is sealed within fluid that is temperature controlled to a desired range to assist in designing a release rate of the Halon 1301 to meet the FAA requirements for a specifically designed cargo hold. The use of our heater element 34 basically is to control the pressure within a defined range compatible with our choice of the flow restrictive orifice 48.

FIG. 4 is a partial view of the metering bottle 26 with a cross section of the components that provide the improved metering operation of our design. An egress port 50 is hermetically sealed to provide an outlet of fire extinguishing fluid. A flow regulator housing 46 has a restrictive orifice 48 mounted permanently in the flow regulator housing 46. A fluid passageway (not shown) in FIG. 4 with an internal orifice that can be as small as 0.010 inch diameter, will provide the precise metering of the fire extinguisher fluid to maintain the 3% Halon 1301 for the extended period in a cargo hold from the metering bottle 26.

A housing 44 that supports a hermetically sealed rupturable disc 45 positions the rupturable disc 45 in a position to enable the cutter 54 on the cutter cartridge 38 to pierce and impale in the disc 45.

FIG. 5 depicts our metering fire bottle 26 shown in FIG. 4, releasing the metered fire extinguishing fluid such as the Halon 1301 after activation of the cutter cartridge 38 by an ignition of the explosive charge 52 to drive the cutter shaft 54 to pierce the ruptured disc 45 in a controlled manner.

FIG. 5 is a cross-sectional view wherein the explosive charge 52 can drive the piston portion of the cutter shaft to proceed forward and pierce the ruptured disc 45 having a thickness of approximately 0.008 inches and align the cutter shaft conduit 56 in an operative position as extending through the ruptured disc 45 and permitting the Halon 1301 to egress into the cutter shaft conduit 56 through the discharge ports 58 that are now upstream of the ruptured disc and likewise downstream to permit a metered release of the Halon 1301 while at the same time providing a secondary restrictive cutter shaft conduit of less than ⅛ inch in diameter. The lower base of our cutter shaft includes an O-ring seal 66 and a flared annular skirt 59 to isolate the explosive charge gas and to prohibit a retraction of the cutter shaft 54 from its pierced location through the ruptured disc 45. As can be further appreciated, the enlarged piston-like end of the cutter shaft provides a limitation as to the extent of movement of the cutter shaft conduit 56 so that it does not interfere or contact the restrictive orifice 48.

Referring to FIG. 4, a threaded nut 64 captures swivel housing 62 which supports the discharge outlet 40. This ensures locking of the components together while also permitting the discharge outlet threaded nozzle to be initially rotated for alignment with discharge tubing that will convey the Halon 1301 to the appropriate cargo hold. An O ring seal 42 assists in preventing leaks and providing some resistance to the rotation of the discharge outlet 40. As known in the aviation industry, appropriate lock wires (not shown) and welds can secure the component parts so that vibrations in the aircraft will not interfere with the structural integrity of our metering system.

Referring to FIG. 6, a schematic of one example of an aircraft with a fire extinguishing system with meter bottles 72 and conduits 76 connecting to a forward cargo compartment 70 with discharge nozzles 78 and an aft and bulk cargo compartments 68 in the rear of the aircraft. Three metered bottles 72 are schematically shown along with two knockdown bottles 74 are disclosed to provide some perspective to the environment of a cargo fire extinguishing systems that exist in the aviation industry.

Our improvements include the use of a cutter pyrotechnic arrangement to ensure a very controlled metered flow condition without experiencing the explosive release of the Halon 1301 that has been utilized in the past along with requiring extraneous filtering and moisture controlled components that would be subject to the sudden release of Halon 1301 upstream of the required metering orifice, as schematically shown in our FIG. 1. We have placed our restrictive metering orifice 48 within the fire extinguishing fluid, such as Halon 1301, that has been pressurized by an inert gas such as nitrogen. Our respective metering orifice 48 is in a sealed portion within a port 50 of the metering bottle 26 and has the advantage of not being affected by external factors of contamination and moisture ingress. While not limited to a Lee restrictive orifice 48, we have utilized one to effect a constant metered flow without any turbulence and surging pressure effects.

We have also incorporated a heater 34 to provide a controlled pressure range of 125 psig to 750 psig while avoiding the previous problems of potentially the low service temperatures, for example −65° F. which can cause both freezing, liquid flow problems and disruption of the metering requirements of 3% Halon 1301. Additionally, we have provided an improved metering system that would not require pre-flight checking of the components and would extend reliability of the metering system and lessen the requirements of checking and verification of the operability of our system.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A metering cargo fire inerting assembly comprising:
a fluid container for storing a pressurized fire extinguishing fluid;
a flow control metering orifice stationary mounted to extend outside of the fluid container's exterior and sealed to the fluid container to enable a controlled release of the fire extinguishing fluid;
a discharge outlet operatively positioned downstream of the flow control metering orifice for directing a released fire extinguishing fluid;
a sealing disc mounted downstream from the flow control metering orifice for preventing the release of fire extinguishing fluid; and
a cutter with an internal fluid flow passageway that is configured to be driven by an explosive pyrotechnic charge for impaling the cutter through the sealing disc to release the fire extinguishing fluid to the discharge outlet for application to a cargo hold.

2. The metering cargo fire inerting assembly of claim 1 wherein the flow control metering orifice and the internal fluid flow passageway limit the release of fire extinguishing fluid to maintain at least 3% by volume of fire extinguishing fluid in the cargo hold for at least 60 minutes.

3. The metering cargo fire inerting assembly of claim 1, further including a heater element mounted to extend within the pressurized fire extinguishing fluid to maintain a predetermined temperature range of the pressurized fire extinguishing fluid.

4. The metering cargo fire inerting assembly of claim 3, wherein the heater element can control a pressurized fire extinguishing fluid of Halon 1301 pressure range from 300 psig to 800 psig.

5. The metering cargo fire inerting assembly of claim 1, further including a timer mounted on the fluid container to automatically release pressurized fire extinguishing fluid for maintaining a 3% by volume of fire extinguishing fluid in the cargo hold.

6. The metering cargo fire inerting assembly of claim 1, further including a timer fastened to the fluid container that can control a time period to actuate the cutter for release of metering pressurized fire extinguishing fluid to the cargo hold.

7. A metering cargo fire inerting assembly comprising:
a fluid container for storing a pressurized fire extinguishing fluid with a port opening for releasing the pressurized fire extinguishing fluid through a port with an opening;
a heater element mounted to extend within the fluid container to heat the fire extinguishing fluid to maintain a predetermined temperature range of the fire extinguishing fluid;
a flow regulator housing mounting a flow control metering orifice and stationarily mounted within and sealed to the port opening to enable an initial controlled release of the pressurized fire extinguishing fluid from the fluid container;
a discharge outlet operatively positioned downstream of the flow control metering orifice for directing a released fire extinguishing fluid;
a sealing disc mounted downstream from the flow control metering orifice and before the discharge outlet for preventing the initial release of the pressurized fire extinguishing fluid; and
a cutter with an internal fluid flow passageway that is configured tro be driven by an explosive pyrotechnic charge for impaling the cutter through the sealing disc to release the fire extinguishing fluid through the internal fluid flow passageway to the discharge outlet for application to a cargo hold,
whereby the flow control metering orifice is enclosed within the heated fire extinguishing fluid prior to a metered release to control a cargo hold fire.

8. The metering cargo fire inerting assembly of claim 7 wherein the flow control metering orifice and the internal fluid flow passageway limit the release of fire extinguishing fluid to maintain at least 3% by volume of fire extinguishing fluid in the cargo hold for at least 60 minutes.

9. The metering cargo fire inerting assembly of claim 7, wherein the heater element can control a pressurized fire extinguishing fluid of Halon 1301 pressure range from 300 psig to 800 psig.

10. The metering cargo fire inerting assembly of claim 7, further including a timer fastened to the fluid container that can control a time period to actuate the cutter for release of metering pressurized fire extinguishing fluid to the cargo hold.

11. A metering cargo fire inerting assembly comprising:
a fluid container for storing a pressurized fire extinguishing fluid;
a flow control metering orifice stationary mounted to extend outside of the fluid container's exterior and sealed to the fluid container to enable a controlled release of the fire extinguishing fluid;
a discharge outlet operatively positioned downstream of the flow control metering orifice for directing a released fire extinguishing fluid;
a sealing disc mounted downstream from the flow control metering orifice for preventing the release of fire extinguishing fluid;
a cutter with an internal fluid flow passageway that is configured to be driven by an explosive pyrotechnic charge for impaling the cutter through the sealing disc to release the fire extinguishing fluid to the discharge outlet for application to a cargo hold; and
a timer fastened to the fluid container that can control a time period to actuate the cutter for release of metering pressurized fire extinguishing fluid to the cargo hold after the initial knockdown release of the fire extinguishing fluid to a cargo hold fire in order to maintain a 3% by volume of fire extinguishing fluid in the cargo hold.

12. The metering cargo fire inerting assembly of claim 11 wherein the flow control metering orifice and the internal fluid flow passageway limit the release of fire extinguishing fluid to maintain at least 3% by volume of fire extinguishing fluid in the cargo hold for at least 60 minutes.

13. The metering cargo fire inerting assembly of claim 11, further including a heater element mounted to extend within the pressurized fire extinguishing fluid to maintain a predetermined temperature range of the pressurized fire extinguishing fluid.

14. The metering cargo fire inerting assembly of claim 13, wherein the heater element can control a pressurized fire extinguishing fluid of Halon 1301 pressure range from 300 psig to 800 psig.

15. The metering cargo fire inerting assembly of claim 13 wherein the cutter is mounted in the discharge outlet to be driven by an explosive pyrotechnic charge to release the fire extinguishing fluid while sealing the resulting gases from the explosion from the released fire extinguishing fluid after the cutter is impaled through the sealing disc and maintained in that position.
